(19) United States
(12) Patent Application Publication
(10) Pub. No.: US 2008/0314392 A1
(43) Pub. Date: Dec. 25, 2008

(54) Limb Supporting Device

(76) Inventors: Robert Letourneau, St. Pierre-Jolys (CA); Karen Letourneau, St. Pierre-Jolys (CA)

Correspondence Address: ADE & COMPANY INC., 2157 Henderson Highway, WINNIPEG, MB, R2G1P9, CA

(21) Appl. No.: 12/140,367

(22) Filed: Jun. 17, 2008

(30) Foreign Application Priority Data
Jun. 19, 2007 (CA) 2598753

(51) Int. Cl. A61G 13/00

(52) U.S. Cl. 128/845

(57) ABSTRACT

A device supports the weight of a limb of a person in a sling through a full range of motion in a generally lateral plane to reduce strain to the person during various procedures. The device comprises a base arm arranged to be supported on a supporting surface, a first swing arm pivotally supported on the base arm; a second swing arm pivotally supported on the first swing arm, a support member vertically slidably on the second swing arm, and an anchor supporting the sling thereon which is pivotal about a vertical axis on the support member. Height adjustment of the sling and anchor relative to the swing arms can be accomplished with a single handed lever operation.

This application claims foreign priority benefits from Canadian Patent Application 2,598,753 filed Jun. 19, 2007.

### FIELD OF THE INVENTION

The present invention relates to a supporting device for suspending at least part of a weight of limb of a person therefrom while the limb remains movable with the supporting device in a generally lateral direction relative to a supporting surface, for example a floor, wall or ceiling, upon which the supporting device is mounted.

### BACKGROUND

In various medical related procedures it is common for an operator of the procedure to be required to be operating above the patient for an elapsed period of time. During an ultrasound procedure for example, the operator must carry the weight of the transducer and/or transducer cable in addition to holding their arm above the patient for an elapsed period of time which can cause considerable strain to the operator.

Examples of various supporting devices can be found in the following U.S. Pat. No. 247,407 belonging to Pistorius, U.S. Pat. No. 5,957,135 belonging to Molina, U.S. Pat. No. 5,279,486 belonging to Harmon and U.S. Pat. No. 4,042,232 belonging to Lile et al. None of the known devices provide adequate support to carry the weight of the operator's arm while at the same time providing a full range of movement to the operator in a generally lateral direction for performing procedures, for example including an ultrasound procedure.

### SUMMARY OF THE INVENTION

According to one aspect of the invention there is provided a supporting device for supporting a limb of a person, the device comprising:

a base arm arranged to be supported on a supporting surface;

a first swing arm supported on the base arm for pivotal movement relative to the base about a first upright axis;

a second swing arm supported on the first swing arm for pivotal movement relative to the first swing arm about a second upright axis spaced horizontally from the first upright axis;

a sling arranged for supporting the limb of the person therein;

an anchor arranged for suspending the sling therefrom;

a support member supporting the anchor on the second swing arm for pivotal movement of the anchor relative to the second swing arm about a third upright axis spaced horizontally from the second upright axis.

By providing a combination of first and second swing arms which are pivotal relative to one another and which support a sling thereon, a full range of motion in a generally lateral plane can be achieved while continuing to support the weight of the operator's arm to reduce strain to the operator. By arranging the sling to be height adjustable, the range of motion can be further increased. When permitting height adjustment to be accomplished with a single handed lever operation, the procedure being accomplished by the operator can be proceeded with out interruption while adjusting the vertical height thereof.

The anchor is preferably adjustable in height relative to the second swing arm and freely pivotal relative to the second swing arm.

The anchor member may also be biased upwardly towards the second swing arm with a height adjustment mechanism being arranged to support the anchor member at one of various heights relative to the second swing arm. The height adjustment mechanism is preferably arranged for single handed operation between locked and unlocked positions respectively.

There may be provided a first height adjustment mechanism arranged to adjustably support an upper portion of the support member on the second swing arm at various relative heights therebetween and a second height adjustment mechanism arranged to support a lower portion of the support member supporting the anchor thereon at various heights relative to the upper portion. The second height adjustment mechanism is preferably controlled by a lever for displacement between respective locked and unlocked positions.

There may be provided a friction control mechanism arranged to vary frictional resistance between the first swing arm and one or both of the base arm and the second swing arm. Accordingly, the frictional control mechanism may control frictional resistance applied to pivotal movement between the first swing arm and the second swing arm or applied to pivotal movement between the first swing arm and the base, preferably independently of one another.

The friction control mechanism may comprise one or more resting positions of the first swing arm relative to a respective one of the second arm and the base arm to which the first swing arm is biased. The resting position may comprise a recess formed on one arm into which a mating part slidably supported on another one of the arms is biased into mating engagement therewith.

When the frictional control mechanism comprises a wheel supported on one of the arms for rotatable engagement with an adjacent one of the arms, there may be provided a friction screw arranged for adjusting frictional resistance applied to rotation of the wheel relative to the arm upon which it is supported.

The support member may be arranged to be supported in fixed relation to the second swing arm while the anchor is arranged to be freely rotatable relative to the support arm about the third upright axis.

The anchor preferably includes a hook suitably arranged for receiving a transducer cord of ultrasound equipment therethrough.

The base arm may include adjustable mounts arranged to adjust inclination of the first upright axis relative to the supporting surface upon which the base arm is supported. The adjustable mounts are preferably arranged to support the base arm on an upright supporting surface such that the first upright axis is adjustable in a first vertical plane oriented generally parallel to the wall and in a second vertical plane oriented generally perpendicularly to the wall.

When supported on a wall, the base arm is preferably arranged to support the first upright axis at the outer end thereof spaced outwardly from the wall upon which the base arm is arranged to be mounted.

The base arm, the first swing arm and the second swing arm may be near in length to one another in a generally horizontal direction.

One embodiment of the invention will now be described in conjunction with the accompanying drawings in which:

### BRIEF DESCRIPTION OF THE DRAWINGS

FIG. 1 is a side elevation view of the device.

FIG. 2 is a top plan view of the device.

FIG. 3 is an end view of the sling supported from the support member.

FIG. 4 is an end view of the base.

FIG. 5 is an exploded perspective view of the base for being supported on an upright supporting surface.

FIG. 6 is a partly sectional elevational view of the support member which supports the sling on the second swing arm.

FIG. 7 is a side elevational view of one of the friction control mechanisms.

FIG. 8 is a top plan view of the friction control mechanism.

FIG. 9 is a perspective view of one embodiment of the hinge between the first and second swing arms.

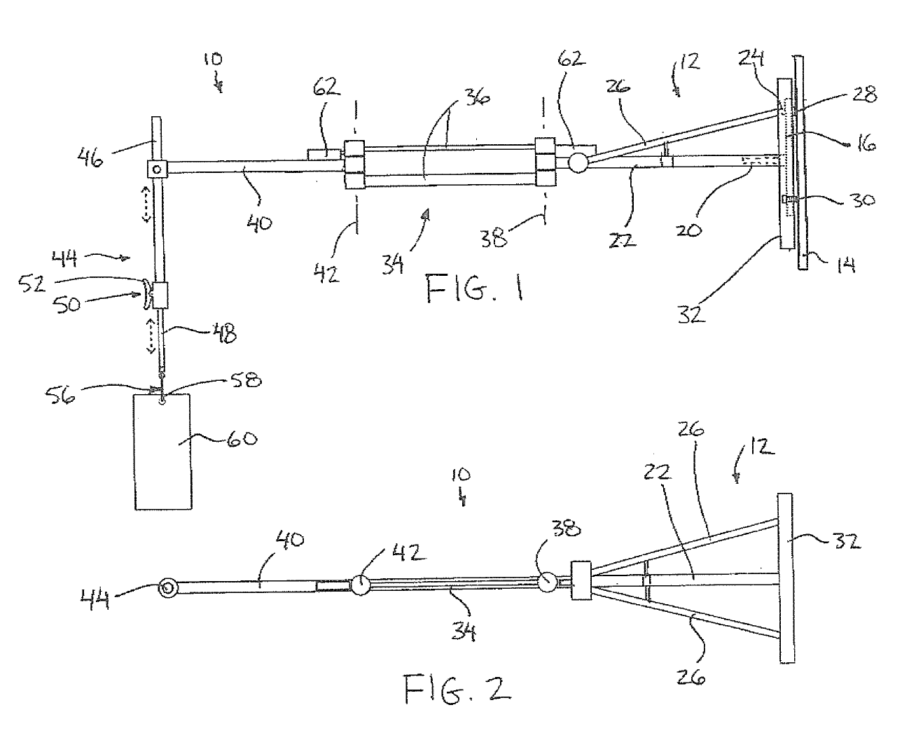

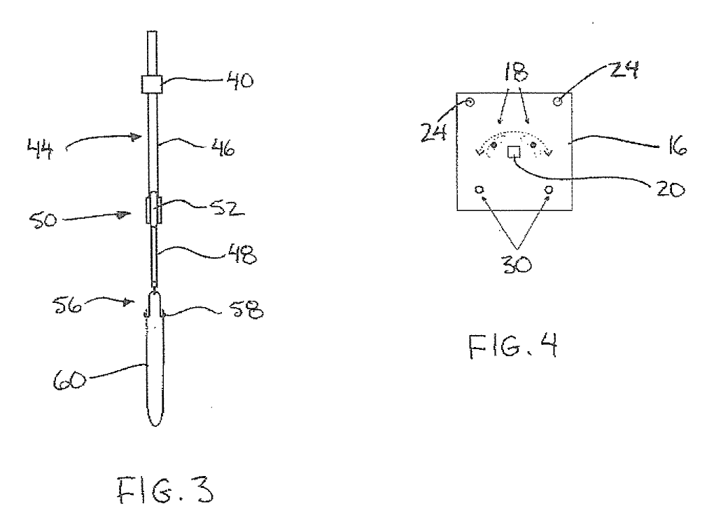

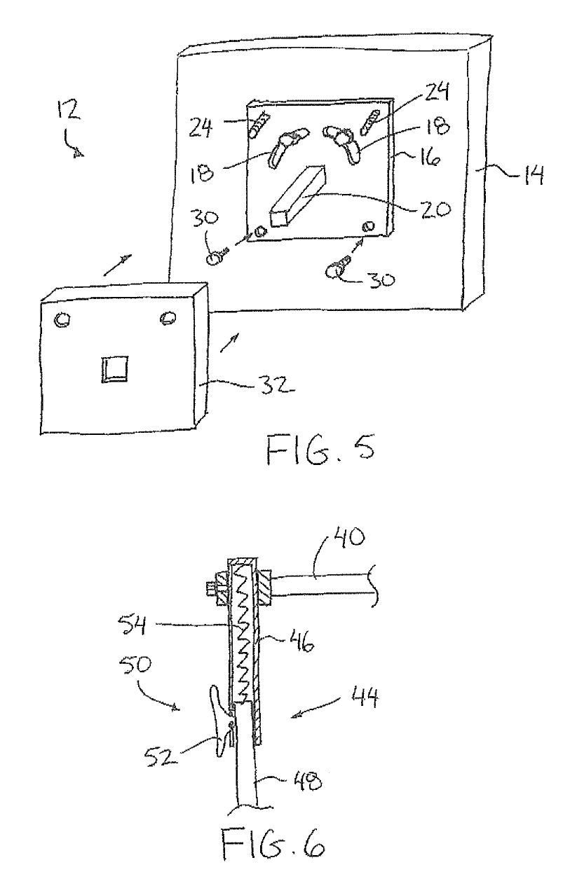

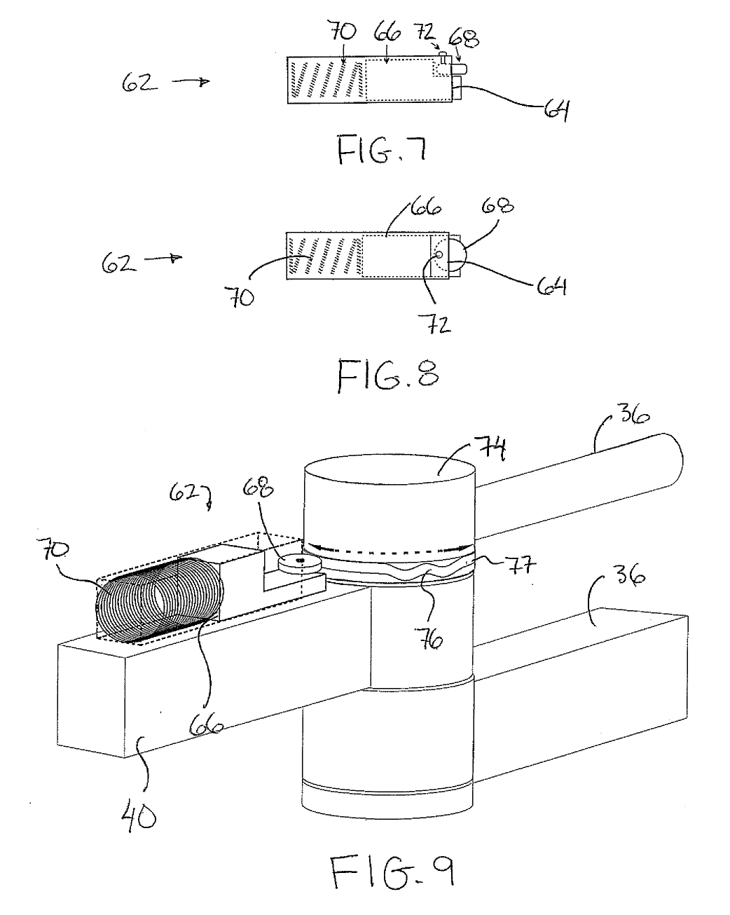

In the drawings like characters of reference indicate corresponding parts in the different figures.

### DETAILED DESCRIPTION

Referring to the accompanying figures there is illustrated a limb supporting device generally indicated by reference numeral 10.

The device 10 is particularly suited for supporting the arm of an operator of equipment in a medical related procedure performed above a patient, for example supporting the arm of a sonographer and transducer of ultrasound equipment during an ultrasound scanning procedure. The device 10 carries the weight of the operator's arm without inhibiting lateral movement in a generally horizontal plane relative to the patient therebelow.

The device 10 includes a base 12 which is arranged for fixed attachment to a supporting surface, for example a wall in the illustrated embodiment. The base may be supported on the floor or ceiling and may be arranged for relative movement, for example being carried on wheels on the floor. The base 12 of the illustrated embodiment is arranged for mounting on a wall.

The base 12 includes a mounting board 14 which is a flat rectangular member arranged to be secured to the wall by suitable fasteners. A mounting plate 16 is secured generally parallel to the mounting board using suitable fasteners. The mounting plate includes a pair of arc shaped apertures 18 to receive the fasteners which secure the plate to the mounting board 14 in which the arc shaped apertures follow a generally common circular path centered on the mounting plate 16. The apertures 18 are positioned nearer to a top edge of the mounting plate 16 so that the mounting plate is generally suspended therefrom when fasteners are received through the apertures. When a single fastener is received within each of the apertures 18, prior to tightening the fasteners, the mounting plate 16 can be tilted from side to side by sliding the fasteners in the respective apertures to properly align the mounting plate relative to the surroundings.

A center post 20 is fixed centrally on the plate to project perpendicularly outward therefrom. The center post is slidably received within the end of a base arm 22 of the base in which the base arm 22 and the center post have a mating square cross section to prevent relative rotation therebetween while permitting the center post to be slidably received into the hollow open end of the base arm.

Two anchors 24 are mounted spaced apart from one another adjacent the top edge of the mounting plate 16 at opposing corners thereof for fastening to respective struts 26 which span between the anchors 24 and the base arm 22 respectively, with the struts joining the base arm at a position spaced outwardly from the mounting plate. The anchors 24 are fastened to the mounting plate 16 using suitable threaded fasteners inserted from the rear side of the plate so that the head of the fasteners define respective lugs 28 to be received between the mounting plate 16 and the mounting board 14 adjacent the top edge thereof.

A pair of levelling bolts 30 are threaded into the mounting plate 16 at spaced positions along the bottom end of the plate for extending through the mounting plate into engagement with the mounting board 14 against which the mounting plate is secured. By varying the amount of insertion of the levelling bolts threaded into the mounting plate, the amount the levelling bolts project from the rear side of the plate between the mounting plate and the mounting board can be controlled for adjusting the up and down tilt of the plate relative to the supporting surface upon which the mounting board is supported.

A cover plate 32 is provided to extend over the mounting plate 16 and mounting board 14 for concealing the fasteners therebetween. The cover plate 32 includes suitable apertures to receive the center post 20 and the struts 26 therethrough, but otherwise conceals the fasteners of the mounting plate.

An outer end of the base arm 22 opposite the mounting plate supports a first swing arm 34 thereon. The first swing arm 34 is elongate between an inner end pivotally supported on the end of the base arm to an outer end which is moveable along an arc shaped path relative to the base. The first swing arm and the base arm are pivotal relative to one another about a first vertical axis 38 with the first swing arm being generally horizontal and accordingly moveable through a generally horizontal plane.

Adjustment of the levelling bolts 30 and positioning of the fasteners within the arc shaped apertures 18 permits orientation of the first vertical axis 38 to be adjusted in respective vertical planes oriented both parallel and perpendicular to the wall to ensure that the vertical axis is properly oriented in a vertical orientation.

The first swing arm 34 comprises two separate arm members 36 which are parallel to one another and vertically spaced apart so that the inner end of one of the members 36 is received above the outer end of the base arm and the other arm member 36 is received below the outer end of the base arm. A collar is provided at the outer end of the base arm 22 which is fixed in relation to the base arm and is arranged to be received concentrically between collars supported on the inner ends of the two arm members 36 respectively. The collars at the outer end of the base arm and at the inner end of the first swing arm are joined by a common pivot shaft to be supported for relative rotation by suitable bearings at the first vertical axis 38 therebetween.

A second swing arm 40 extends generally horizontally between a respective inner end and a respective outer end in which the inner end is pivotally coupled to the outer end of the first swing arm for relative rotation therebetween about a respective second vertical axis 42. Similar to the hinge at the first vertical axis 38, the second swing arm 40 comprises a single arm locating a collar fixed at the inner end thereof which is received between a pair of collars fixed to the outer ends of the respective two arm members 36 of the first swing arm 34 respectively. The collars at the second vertical axis 42 are joined by a common pivot shaft received concentrically therethrough for relative rotation between the collars by suitable bearings.

The second swing arm 40 also includes a collar fixed at the outer free end thereof which is moveable in an arc shaped path about the second vertical axis 42. A support member 44 is received through the collar at the outer end of the second swing arm for sliding movement in a vertical direction through the collar to be adjustable in height relative to the swing arms.

The support member 44 generally comprises a vertical post having an upper part 46 which is received in the collar at the outer end of the second arm, and a lower part 48 telescopically received in the upper part 46 for relative sliding movement in a vertical direction therebetween. A suitable set screw is provided at the collar at the outer end of the second arm for selective fixing position of the upper part 46 of the support member at a selected height relative to the swing arms.

A lever actuated cam lock 50 is coupled between the upper and lower parts of the support member at the bottom end of the upper part 46. The cam lock 50 is arranged to allow sliding movement between the upper and lower parts when released while restricting relative sliding movement therebetween when engaged into a locked position. The cam lock 50 includes a lever 52 which can be readily operated by a single hand of the operator for displacement between the locked and unlocked positions.

A spring 54 is received within the upper part 46 of the support member to be coupled between the top end of the upper part 46 and the top end of the lower part 48. The spring 54 acts to bias the lower part upwardly to be retracted into the upper part. When applying weight to the lower part when the cam lock 50 is released, the lower part 48 will be lowered in relation to the swing arms, however when releasing weight applied to the lower part, the spring 54 will cause the lower part to retract into the upper part to effectively raise the lower in relation to the swing arms. Returning the lever of the cam lock 50 to the locked positions effectively permits a new height of the lower part of the support member relative to the swing arms to be selected.

An anchor 56 is coupled to the bottom end of the support member for free pivotal movement about a respective third vertical axis 58. The anchor is movable up and down with the lower part of the support member relative to the upper part of the support member and the swing arms. The anchor 56 comprises suitable hooks 58 upon which a sling 60 can be suspended. The anchor also includes a suitable eyelet for receiving the cord of the transducer therethrough if desired to also carry some of the weight of the transducer on the support member of the device 10.

Each of the hinges at the first axis and the second axis respectively include a friction control mechanism 62 to control how freely the first swing arm pivots relative to the second swing arm and how freely the second swing arm pivots relative to the base arm respectively. At the second vertical axis 42, the control mechanism 62 comprises a housing supported on the second swing arm in fixed relation therewith which has an open end 64 facing the collar at the end of the upper one of the two arm members 36 forming the first swing arm. A slider 66 is mounted within the housing and includes a wheel 68 rotatable supported about a vertical axis at an end of the slider 66 for rotatable engagement on the upper collar fixed on the outer end of the first swing arm.

The wheel 68 comprises a soft rubber or nylon material for engagement on the rigid metal collar at the end of the first swing arm. A spring 70 is received within the housing between the slider and the housing to act in a direction which urges the slider 66 and wheel 68 supported thereon into engagement with the collar of the first swing arm so that the wheel rides on the collar as the second swing arm is pivoted relative to the first swing arm.

A friction screw 72 is mounted on the housing of the friction control mechanism 62 for selective engagement with the wheel 68 to vary the amount of friction applied to the wheel between the wheel and the housing fixed on the second swing arm which in turn varies the amount of frictional resistance applied between relative pivotal movement of the second swing arm relative to the first swing arm. Releasing the friction screw 72 causes the second swing arm to be freely pivotal relative to the first swing arm, or alternatively, tightening the friction screw 72 can cause greater frictional resistance therebetween.

The collar 74 on the first swing arm which is engaged by the wheel 68 of the friction control mechanism 62 may comprise a smooth outer surface which is circular upon which the wheel 68 rolls.

As illustrated in the example of FIG. 9, the collar 74, at the end of the first swing arm 34, may also define one or more parked or rest positions corresponding to a relative orientation between the arms to which the arms are biased when the arms approach said relative orientation. In the illustrated example of FIG. 9, two rest positions are defined diametrically opposite one another. At each rest position on the collar 74, a pair of protrusions, which project generally radially outward relative to the vertical axis, define a corresponding recess 76 therebetween, which matingly receives the wheel 68 of the friction control mechanism therein. The wheel can ride over the protrusions when the slider is retracted within the housing of the friction control mechanism to compress the spring. Accordingly the spring acts in a direction to urge or bias the wheel of the friction control mechanism into the recess between each pair of protrusions, thus biasing the arms into one of a plurality of circumferentially spaced rest positions, when the arms approach a relative orientation corresponding to the wheel engaged in the recess.

The pairs of protrusions defining the two recesses 76 are commonly supported on an annular member 77 which is rotatable within a respective groove about the corresponding vertical axis. Accordingly the position of the rest positions and corresponding relative orientation of the arms can be adjusted. A set screw permits the annular member to be fixed in relation to the collar 74 as desired to fix the position of the recesses and corresponding rest positions as desired by the user. The rest positions are particularly useful when the relative orientation of the arms corresponds to the arms being folded against one another or against the supporting surface for storage for example. The remaining surface of the collar 74 upon which the wheel 68 rides is smooth in the preferred embodiment so that no protrusions or recesses interfere with smooth relative motion of the arms relative to one another in use.

The friction control mechanism 62 between the first swing arm and the base arm can be arranged similarly, with the exception of the housing of the mechanism being fixed on the base arm and the wheel riding on the collar at the inner end of the first swing arm.

In use, when supporting the device is on an upright supporting surface such as a wall, the mounting board 14 is first secured to the wall and the mounting plate is then attached thereto with the levelling bolts 30 and the arc shaped apertures 18 being used to align the base properly so that the first vertical axis 38 at the outer end of the base arm is in fact vertical in orientation and the swing arm and base arm are effectively horizontal. Position of the upper part 46 of the support member 44 is then set in the collar at the outer end of the second swing arm so that the sling is located within a range of movement of the lower part 48 of the support member 44 that is near the patient above which the device is supported.

The arm of the operator of a medical related procedure is then inserted through the sling supported at the anchor with equipment used by the operator such as the cord of ultrasound transducer also being arranged to be supported by the anchor. In the illustrated embodiment the base arm, the first swing arm and the second swing arm are all near in length with one another so as to position the sling at the outer end of the second swing arm for an optimal range of motion relative to a patient therebelow.

In other environments when the base is supported on a wheeled frame on the floor, or on a wall which is very far from the patient for example, the configuration of the base arm can be varied.

During the medically related procedure, if the operator wishes to vary the supported height of their arm within the sling, the operator can release the cam lock 50 using the lever 52 which is operated by a single hand of the operator so that simply raising or lowering the arm in the sling will cause the lower part 48 of the support member to be either pulled downwardly with the sling or retracted upwardly under action of the biasing spring 54. The operator can then reengage the cam lock 50 into a locked position using the single hand operated lever 52 to set the sling at a new selected height.

The first height adjustment of the support member relative to the second swing arm using the collar at the outer end of the second swing arm is useful for broad ranges of height selection whereas the height adjustment provided by the cam lock 50 is more suited to more fine height adjustments during use of the device in a medical related procedure for example. The sling and the anchor 56 upon which it is supported remain freely pivotal relative to the support member while relative pivotal movement between the first and second swing arms and the first swing arm and the base arm can be controlled with adjustable frictional resistance according to the preference of the user.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A supporting device for supporting a limb of a person, the device comprising:
a base arm arranged to be supported on a supporting surface;
a first swing arm supported on the base arm for pivotal movement relative to the base about a first upright axis;
a second swing arm supported on the first swing arm for pivotal movement relative to the first swing arm about a second upright axis spaced horizontally from the first upright axis;
a sling arranged for supporting the limb of the person therein;
an anchor arranged for suspending the sling therefrom;
a support member supporting the anchor on the second swing arm for pivotal movement of the anchor relative to the second swing arm about a third upright axis spaced horizontally from the second upright axis.

2. The device according to claim 1 wherein the anchor is adjustable in height relative to the second swing arm.

3. The device according to claim 2 wherein the anchor member is biased upwardly towards the second swing arm.

4. The device according to claim 1 wherein there is provided a height adjustment mechanism arranged to support the anchor member at one of various heights relative to the second swing arm, the height adjustment mechanism being arranged for single handed operation between locked and unlocked positions respectively.

5. The device according to claim 1 wherein there is provided a first height adjustment mechanism arranged to adjustably support an upper portion of the support member on the second swing arm at various relative heights therebetween and a second height adjustment mechanism arranged to support a lower portion of the support member supporting the anchor thereon at various heights relative to the upper portion.

6. The device according to claim 5 wherein the second height adjustment mechanism is controlled by a lever for displacement between respective locked and unlocked positions.

7. The device according to claim 1 wherein there is provided a friction control mechanism arranged to vary frictional resistance between the first swing arm and at least one of the base arm and the second swing arm.

8. The device according to claim 7 wherein the anchor is freely pivotal relative to the second swing arm.

9. The device according to claim 7 wherein the frictional control mechanism controls frictional resistance applied to pivotal movement between the first swing arm and the second swing arm.

10. The device according to claim 7 wherein the frictional control mechanism controls frictional resistance applied to pivotal movement between the first swing arm and the base.

11. The device according to claim 7 wherein the frictional control mechanism permits frictional resistance to be varied independently between the first swing arm and the base arm and between the first swing arm and the second swing arm.

12. The device according to claim 7 wherein the friction control mechanism comprises at least one resting position of the first swing arm relative to a respective one of the second arm and the base arm to which the first swing arm is biased.

13. The device according to claim 12 wherein said at least one resting position comprises a recess formed on one arm into which a mating part slidably supported on another one of the arms is biased into mating engagement therewith.

14. The device according to claim 7 wherein the frictional control mechanism comprises a wheel supported on one of the arms for rotatable engagement with an adjacent one of the arms and wherein there is provided a friction screw arranged for adjusting frictional resistance applied to rotation of the wheel relative to the arm upon which it is supported.

15. The device according to claim 1 wherein the support member is arranged to be supported in fixed relation to the second swing arm and the anchor is arranged to be freely rotatable relative to the support arm about the third upright axis.

16. The device according to claim 1 wherein the anchor includes a hook suitably arranged for receiving a transducer cord of ultrasound equipment therethrough.

17. The device according to claim 1 wherein the base arm includes adjustable mounts arranged to adjust inclination of the first upright axis relative to the supporting surface upon which the base arm is supported.

18. The device according to claim 17 wherein the adjustable mount is arranged to support the base arm on an upright supporting surface such that the first upright axis is adjustable in a first vertical plane oriented generally parallel to the wall and in a second vertical plane oriented generally perpendicularly to the wall.

19. The device according to claim 1 wherein the base arm is arranged to support the first upright axis at the outer end thereof spaced outwardly from an upright supporting surface upon which the base arm is arranged to be mounted.

20. The device according to claim 19 wherein the base arm, the first swing arm and the second swing arm are near in length to one another in a generally horizontal direction.
